(19) United States
(12) Patent Application Publication
(10) Pub. No.: US 2011/0063856 A1
(43) Pub. Date: Mar. 17, 2011

(54) FLASHLIGHT LENS ASSEMBLY ADAPTED FOR BEAM OPTIMIZATION

(75) Inventors: Joseph Noah Mintz, Carlsbad, CA (US); Jeffrey Lewis Amram Summit, Jefferson, MA (US); Fernando Erismann, Long Island City, NY (US)

(73) Assignee: NOVATAC, Inc., Carlsbad, CA (US)

(21) Appl. No.: 12/855,694

(22) Filed: Aug. 12, 2010

Related U.S. Application Data
(60) Provisional application No. 61/233,197, filed on Aug. 12, 2009.

(51) Int. Cl. F21V 5/00

(52) U.S. Cl. 362/331

(57) ABSTRACT

A lens assembly is provided for use with a flashlight or similar apparatus, the lens assembly provides separate optimization of a first beam of light and a second beam of light. The lens assembly is adapted for use in multiple LED applications, such as the use of white and infrared light beams in a single flashlight apparatus.

### CROSS-REFERENCE TO RELATED APPLICATIONS

This invention relates to U.S. Provisional Patent Application No. 61/233,197 entitled “MULTI-SOURCE FLASHLIGHT ASSEMBLY”, and filed Aug. 12, 2009; the entire contents of which are hereby incorporated by reference.

### FIELD OF THE INVENTION

This application relates generally to flashlights, more particularly to reflector and lens assemblies for directing multiple light sources into an optically focused beam.

### BACKGROUND OF THE INVENTION

Flashlights are well known in the art, and useful in many applications including fixed mount and portable lighting applications. More recently, Light Emitting Diodes (LEDs) have been incorporated into flashlights. LED flashlights are useful because of their low power consumption in comparison to incandescent bulb flashlights. Typical LED flashlights include one or more LED bulbs disposed around a reflector piece. The reflector piece serves to direct the light from the multiple-LEDs into a generally focused beam. The beam produced by these types of LED flashlights tends to be ineffective at large distances; such as distances greater than 15 feet. Although the beam of these multiple-LED flashlights is not optimized for larger distances, these LED flashlights generally provide a cost effective and long lasting portable light source.

In about 2001, Philips® released the LumiLED, a high-power light emitting diode (LED). Since this time, several manufactures offer similar high-power LEDs, which generally consist of a diode fixed to a base, and a heat transfer plate on the base for dissipating heat. The LumiLED and other high power LEDs provide significantly more light than traditional LEDs, however the added energy comes at a cost of increased heat. If the heat provided by the high-power LED is not efficiently dissipated, the LED will prematurely burn out. Because of this problem, many heat sinks have been designed and provided for use with these high-power LEDs. The heat sinks are generally in thermal communication with the heat transfer plate of the high power LED, thereby effectively dissipating heat.

With the advancement of the high power LED (HPLED), came an incorporation of these HPLEDs into flashlights and other useful products. Several flashlight manufacturers have provided HPLED flashlights which are currently available in the flashlight market.

Other manufacturers have developed flashlights that provide a white LED, and an additional LED, usually in a separate color or non-visible spectrum such as Infrared (IR). One problem with currently available multiple LED flashlights is that the white LED is usually located in the center of a reflector, providing a focused beam of white light, while the alternative color LEDs are located somewhere other than the center of the reflector, or radially adjacent to the white LED, and therefore the beam associated with the alternative LED is scattered and non-optimized, especially at distances greater than 15 feet.

There is a need in the art for a multi-LED flashlight assembly that provides both; a focused beam of white light, and a focused beam of an alternative color light. There is also a need for a multi-LED flashlight that can provide both white light and Infrared, independently and collectively, in a focused beam at 50-75 feet. Further, there is a need for a multi-LED light to provide these features at continued operation for at least 24 hours.

Military combat units, such as the Army Special Forces and similar military organizations would be of particular benefit to a multi-source HPLED flashlight having each source LED associated with an optically focused beam at distances greater than 15 feet. For example, the use of Infrared (IR) light to enhance visual characteristics under the operation of tactical night vision is of a particular benefit, especially with an optically focused beam. With a focused beam of IR light, a soldier may be able to clearly recognize friendly and enemy forces under the operation of night vision in the dark.

Hikers, boaters, and other recreational users of flashlights would further benefit from multiple source LED flashlights having a focused white LED source beam as well as an optically focused alternative beam, such as infrared, red, green, yellow, or other light.

It is therefore an object of the invention to provide a lens assembly adapted to receive a plurality of LEDs, each LED adapted to emit light into an optically focused beam at distances greater than 15 feet.

Other objects of the invention will become apparent to one having skill in the art upon further review of the contained description of the embodiments of the invention.

### SUMMARY OF THE INVENTION

According to various embodiments of the invention, a reflector assembly is provided for use in flashlights and other light emitting products; the reflector assembly being adapted to receive a first LED and a second LED, wherein at least one of the first and second LEDs is a High Power Light Emitting Diode (HPLED). The reflector assembly comprises a first substantially conical lens portion having a base disposed at a proximal end, the base further adapted to receive one of a standard LED, or a HPLED. The base may comprise a concave portion for at least partially receiving a penetrating end of the received LED. The reflector assembly further comprises a second substantially conical lens portion having a base disposed at a proximal end. Each of the first and second substantially conical lens portions extending outwardly from the respective base to a distal end. The second substantially conical lens portion further comprises a notch for conforming about the first substantially conical lens portion along a side edge. The first and second lens portions are attached along the side edge using a solvent, adhesive, or other bonding agent. The reflector assembly may further include a distal lens, the distal lens being substantially circular and having a diameter adapted to substantially cover all portions of the lens assembly. In a preferred embodiment, the lens assembly comprises a first lens portion adapted to receive a first LED, a second lens portion adapted to receive a second LED, and a distal lens attached to a distal end of the first and second lens portions, the distal lens adapted to extend along at least the entire surface of the first and second lens portions at the distal end.

The multi-functional flashlight can be used to provide white light, infrared light, colored light such as red, orange, yellow, green, blue, purple, or any combination or blend thereof.

In one embodiment, a flashlight includes a white LED source and an Infrared (IR) LED source. The white LED source and the IR LED source are controlled by a controller located within the flashlight, and can be switched on or off by the user of the flashlight. The user can switch between modes such as activating the white LED only, IR LED only, both White and IR led, or all LEDs turned off. Other modes are possible, such as strobe, etc.

The reflector assembly includes multiple lens portions which are attached or bonded into one reflector assembly piece. Each reflector assembly can be machined or molded. Each reflector assembly can be fabricated from a polymer, such as polycarbonates, acrylics and other polymers.

In a preferred embodiment, the reflector assembly includes a white light lens portion and an IR lens portion, wherein each lens portion is optically focused to emit a beam of light at distances greater than 15 feet. The white light lens portion is molded from a polycarbonate, and the IR lens portion is molded from an acrylic, such that light will be reflected along translucent edges of the first and second lens portions. The lenses can optionally be coated with an optical coating such as an anti-glare coating, anti-scratch coating, or AR coating.

### BRIEF DESCRIPTION OF THE DRAWINGS

The invention can be further understood by one having skill in the art with particular reference to the appended figures, wherein:

FIG. 1 illustrates a multi-LED lens assembly adapted for use in a flashlight, the lens assembly including a first lens portion and a second lens portion coupled to the first lens portion, the lens assembly further including a distal lens and a pair of LEDs connected to a thermal dissipating heat sink.

FIG. 2 illustrates the lens assembly according to FIG. 1, wherein the distal lens is substantially circular.

FIG. 3 illustrates a lens assembly according to an embodiment of the invention, wherein the distal lens is coupled to a distal surface of the first lens portion.

FIG. 4 illustrates an embodiment of the invention, wherein a first lens portion extends outwardly in a substantially conical shape to a circular distal surface, the first lens portion is coupled to a second lens portion along a first side surface and a second lens portion along a second side surface; the first through third lens portions are horizontally aligned along a common plane.

FIG. 5 is a bottom perspective view of the lens assembly of FIG. 4; wherein a HPLED is received by the first lens portion, and standard LEDs are received within the second and third lens portions.

FIG. 6 illustrates another embodiment of the invention, wherein a first conical lens body is adapted to receive a first LED, and a second conical lens body is adapted to receive a second LED, the first and second conical lens bodies are not coupled along a side surface.

FIG. 7 illustrates an embodiment of the invention, wherein a first conical lens body is adapted to receive a first LED, and a second conical lens body is adapted to receive a second LED, the first and second conical lens bodies are coupled along a side surface.

FIG. 8 is a top view of the distal end of the lens assembly according to the embodiment of FIG. 7.

FIGS. 9(a-c) illustrate a lens assembly according to an embodiment of the invention, wherein a first lens portion is coupled to a second lens portion and a third lens portion at a side surface, the second and third lens portions are aligned linear along a common plane; and wherein a distal lens is adapted to cover only the distal surface of the first lens portion.

### DETAILED DESCRIPTION

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention. Certain embodiments will be described below with reference to the drawings wherein illustrative features are denoted by reference numerals.

A flashlight lens assembly is provided, the flashlight lens assembly adapted to receive a first light emitting diode (LED) and a second light emitting diode for use with a flashlight or similar article. The lens assembly includes a first lens portion for at least partially receiving a first LED at a first base. During operation of the first LED, light emitting therefrom is optically confined and oriented within the first lens portion to extend outwardly from the lens portion in an optically focused beam. The lens assembly further includes a second lens portion having a second base for at least partially receiving a second LED. The first lens portion is coupled to the second lens portion along a side surface. The term “coupled” is used herein to describe a physical alignment or proximity between two structures; the term coupled may be used to describe two concentrically disposed objects which are not physically attached or bonded, or alternatively the term “coupled” may be used to describe attached or bonded objects.

During operation, light emitted from the second LED is optically confined within the second lens portion and is prevented from entering the first lens portion. This can be accomplished by fabricating the first and second lens portions from different materials, such as acrylic and polycarbonate polymers. Because differing materials may comprise dissimilar optical characteristics, it is possible to prevent light from entering either of the first of second lens portions at a side surface by fabricating the first and second lens portions from different materials, thereby creating a substantially translucent side surface as light is not permitted to travel from a first lens portion to a second lens portion. The first lens portion can comprise a first translucent side surface and the second lens portion can comprise a second translucent side surface. Alternatively, each of the first and second lens portions may be wrapped or coated with a translucent material.

The first lens portion of the lens assembly generally includes a first base disposed at a proximal end for at least partially receiving a first light emitting diode. The first lens portion is characterized by a conical shaped body extending outwardly from the first base to a substantially circular distal surface.

Similarly, the second lens portion of the lens assembly generally includes a second base disposed at a proximal end for at least partially receiving a second LED. The second lens portion is characterized by a substantially conical shaped body extending outwardly from the second base to a crescent shaped distal surface.

As described above, the first lens portion is coupled to the second lens portion along a side surface. Optionally, the first lens portion can be physically attached or bonded to the second lens portion using a solvent or adhesive.

In one embodiment, the substantially circular distal surface of the first lens portion can be aligned substantially coplanar with respect to the crescent shaped distal surface of the second lens portion.

One or more of the first and second base can be adapted to at least partially receive an LED. For example, the first base can include a recessed portion, such as a dome shaped recessed portion, the recessed portion adapted to receive a light emitting end of an LED. Up to all lens portions may be adapted with a recessed portion for receiving an LED. Alternatively, up to each of the lens portions may be adapted with a blunt base for receiving light emitted from an LED.

In certain embodiments of the invention, the lens assembly may further include a distal lens. The distal lens can be coupled to one or more of the first and second lens portions at their respective distal surfaces. The distal lens can be circular shaped, oval shaped, or other shape, and can be fabricated from a similar or different material than the first or second lens portions. The distal lens may further include an optical coating for anti-fig, anti-glare, or similar coatings known in the art. The distal lens can have a thickness greater than a thickness of the lens portions.

The first and second bases can be aligned in a common plane, for example where the first and second received LEDs are substantially similar. However, in an alternative embodiment the first base can be adapted to receive a high power light emitting diode (HPLED) and the second base can be adapted to receive a standard LED; the first base may be disposed in a separate plane to accommodate differing heights of the HPLED and standard LED, respectively.

The lens assembly may further include a third lens portion. The third lens portion including a third base disposed at a proximal end for at least partially receiving a third LED. The third lens portion is further characterized having a substantially conical shaped body extending outwardly from the third base to a crescent shaped distal surface. The crescent shaped distal surface of the third lens portion can be disposed opposite of the crescent shaped distal surface of the second lens portion, such that each of the second and third lens portions can adjacently conform about the first lens portion. In this regard, the second lens portion is adjacently disposed on a first side of the first lens portion, and the third lens portion is adjacently disposed on a second side of the first lens portion, wherein the second side is opposite of the first side. The first through third lens portions can be linearly disposed along a common plane for symmetry. A distal lens can be provided for covering one or more of the distal surfaces of the first through third lens portions of the lens assembly.

In one embodiment, the first lens portion can be adapted to receive a white light HPLED. The second and third lens portions can be disposed on opposite sides of the first lens portion, and can be adapted to receive an infrared LED. In this regard, the center beam can be optimized for emitting white light; and the outer beams can be optimized for emitting infrared light. Alternatively, three or more distinct light wavelengths can be utilized in a similar assembly.

The lens assembly can include a plurality of lens portions. In certain embodiments, each of the lens portions can be symmetrically disposed radially about a central lens portion.

The lens assembly according to each of the embodiments disclosed is designed to optically enhance received light into separate, optically focused beams. It is important to optically focus beams of light for use at distances greater than fifteen feet. The embodiments of the invention have achieved optical efficiency at distances of fifty feet and greater.

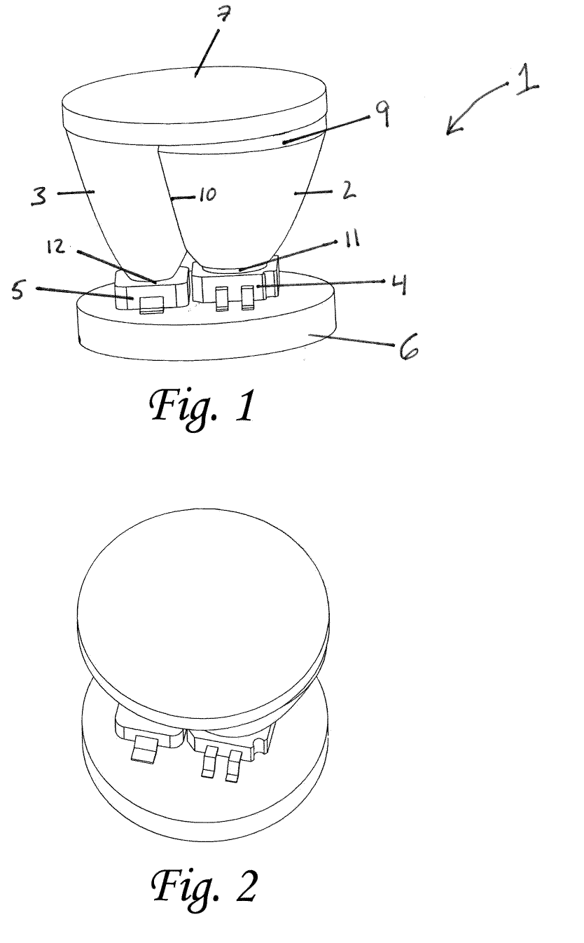

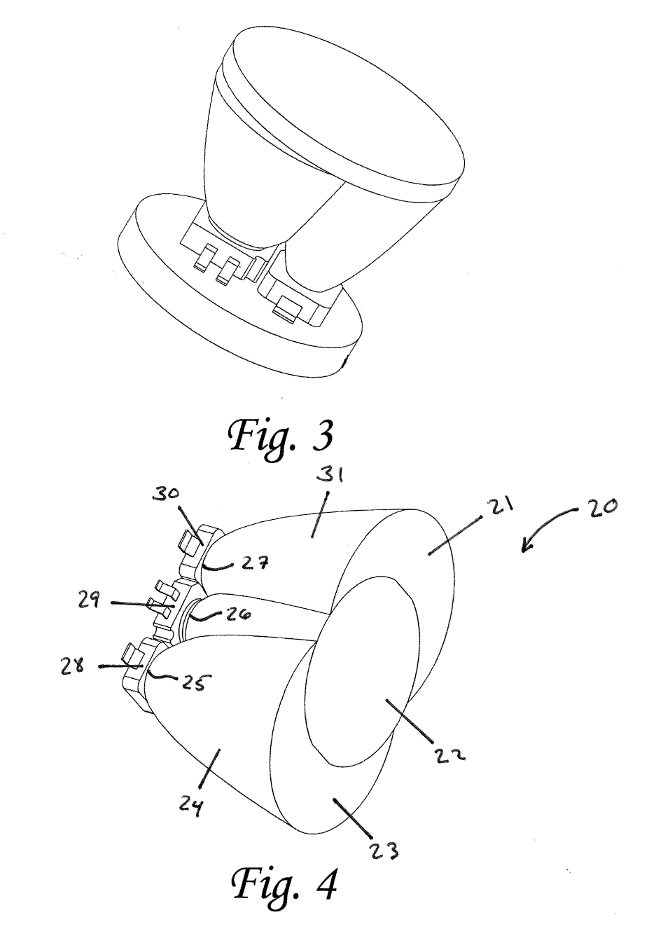

Turning now to the figures, FIGS. 1-3 illustrate an embodiment of the invention, wherein a lens assembly 1 is provided for use with a flashlight or similar article. The lens assembly 1 includes a first lens portion 2 having a first base 11 disposed at a proximal end and extending in a conical shape to a circular distal surface 9. The lens assembly 1 further includes a second lens portion 3 having a second base 12 disposed at a proximal end and extending outwardly in a substantially conical shape to a distal surface having a crescent shape 8. The first lens portion 2 is coupled to the second lens portion 3 at a side surface 10. The first base 11 is adapted to receive a first LED 4 and the second base 12 is adapted to receive a second LED 5. A distal lens 7 is further included, the distal lens 7 coupled to the distal surface 8 of the second lens portion. A heat sink 6 or other thermal dissipating member can be used to dissipate heat from the one or more HPLEDs.

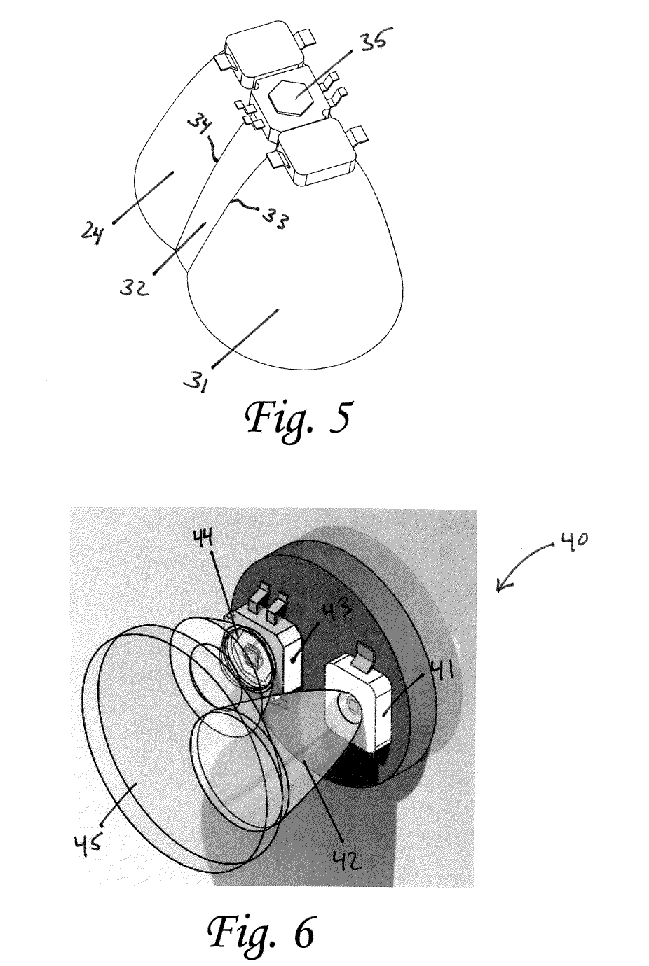

FIGS. 4-5 illustrate another embodiment of the invention disclosing a lens assembly 20, wherein a first lens portion 32 is centered between a second lens portion 24 and a third lens portion 31. The first lens portion 32 includes a first base 26 adapted to receive a first LED 29. The first lens portion 32 further comprises a conical extruded body extending outwardly from the first base 26 to a circular distal surface 22. The second lens portion 24 includes a second base 25 for receiving a second LED 28. The second lens portion 24 further comprises a conical extruded body extending outwardly from the second base 25 to a crescent shaped distal surface 23. The second lens portion 24 is coupled to the first lens portion 32 along a side surface 34. The third lens portion 31 includes a third base 27 for receiving a third LED 30. The third lens portion 31 further comprises a conical extruded body extending outwardly from the third base to a crescent shaped distal surface 21. The third lens portion 31 is coupled to the first lens portion 32 along a side surface 33. The distal surfaces 21; 22; 23 of each of the first through third lens portions are aligned within a common plane.

FIG. 6 illustrates another embodiment of the invention, wherein a lens assembly 40 includes a first conical shaped lens portion 42 adapted to receive a first LED 41, and a second conical shaped lens portion 44 adapted to receive a second LED 43. The first lens portion 42 and second lens portion 44 are not coupled along a side surface, but are configured to stand freely. A distal lens 45 is provided; the distal lens 45 is coupled to a distal surface of the first lens portion 42.

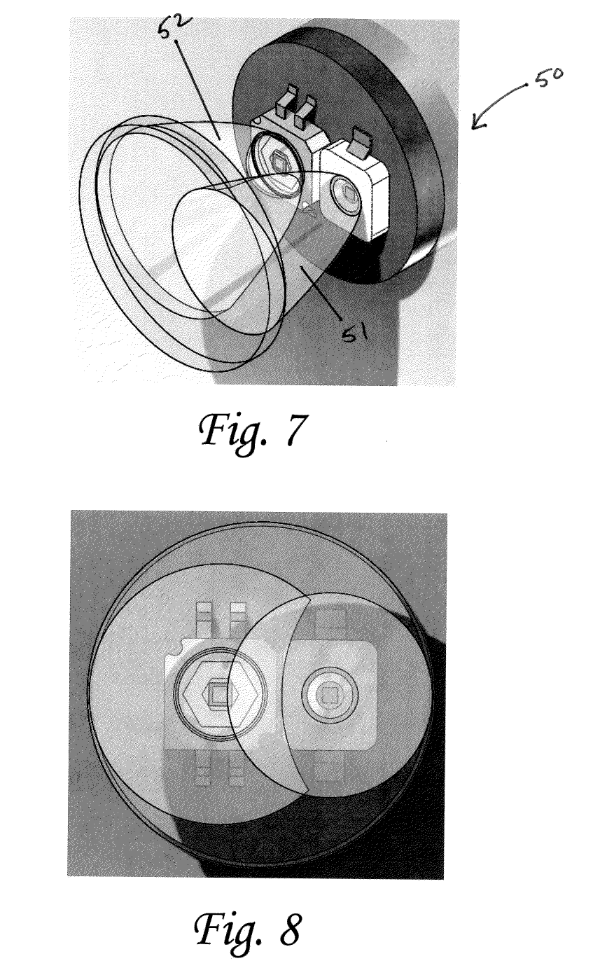

FIGS. 7-8 illustrate an alternative embodiment 50 to FIG. 6, wherein the second lens portion 52 is coupled to the first lens portion 51 along a side surface. The distal lens is coupled to the first and second lens portions at their respective distal surfaces.

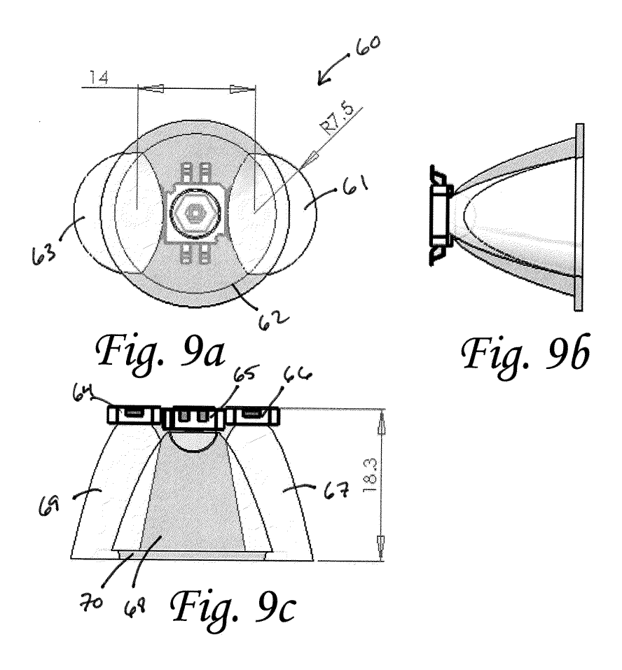

FIGS. 9(a-c) represent a front, side, and top surface of the lens assembly, respectively, according to an embodiment of the invention, wherein a first lens portion 68 is disposed at center, the first lens portion 68 adapted to receive a first LED 65. The first lens portion 68 includes a first base and extends outwardly from the first base to form a conical shaped body having a circular distal surface 62. The lens assembly further includes a second lens portion 67 disposed along a first side of the first lens portion 68. The second lens portion 67 includes a second base and extends outwardly from the second base to a second distal surface 61, wherein the second distal surface 61 is substantially crescent shaped. A third lens portion 69 is provided, the third lens portion 69 being substantially similar to the second lens portion 67 and disposed on an opposite side of the first lens portion 68. The second and third lens portions extend outwardly beyond the first distal surface of the first lens portion. A distal lens 70 is further provided to rest above the first distal surface in between the second and third lens portions 67; 69. The first through third lens portions are horizontally aligned along a common plane.

The above examples are set forth for illustrative purposes and are not intended to limit the spirit and scope of the invention. One having skill in the art will recognize that deviations from the aforementioned examples can be created which substantially perform the same functions and obtain similar results.

What is claimed is:

1. A flashlight lens assembly, comprising:
a first lens portion; and
a second lens portion;
the first lens portion including a first base disposed at a proximal end for at least partially receiving a first light emitting diode (LED), and having a conical shaped body extending outwardly from said first base to a substantially circular distal surface;
the second lens portion including a second base disposed at a proximal end for at least partially receiving a second LED, and having a substantially conical shaped body extending outwardly from said second base to a crescent shaped distal surface;
wherein said first lens portion is coupled to said second lens portion along a side surface.

2. The lens assembly of claim 1, wherein said substantially circular distal surface of said first lens portion is substantially coplanar with said crescent shaped distal surface of said second lens portion.

3. The lens assembly of claim 1, further comprising a distal lens, wherein said distal lens is coupled to at least one of said first and second lens portions at said distal surface.

4. The lens assembly of claim 1, wherein at least one of said first and second base further includes a recessed portion for at least partially receiving a light emitting diode.

5. The lens assembly of claim 1, wherein said first and second base are disposed in a common plane.

6. The lens assembly of claim 1, wherein at least one of said first and second base is adapted to at least partially receive a high power light emitting diode (HPLED).

7. The lens assembly of claim 1, further comprising a third lens portion; said third lens portion including a third base disposed at a proximal end for at least partially receiving a third LED, and having a substantially conical shaped body extending outwardly from said third base to a crescent shaped distal surface.

8. The lens assembly of claim 7, further comprising a distal lens adapted to cover a distal surface of at least one of said first through third lens portions.

9. The lens assembly of claim 8, wherein said second lens portion is adjacently disposed on a first side of said first lens portion, and said third lens portion is adjacently disposed on a second side of the first lens portion, wherein said second side is opposite of said first side.

10. The lens assembly of claim 9, wherein said first through third lens portions are linearly disposed along a common plane.

11. The lens assembly of claim 1, wherein said first lens portion is bonded to said second lens portion along said side surface.

12. The lens assembly of claim 1, wherein said bonded surface is formed from one of a solvent or adhesive.

13. The lens assembly of claim 1, wherein said first lens portion is fabricated from a first material.

14. The lens assembly of claim 13, wherein said second lens portion is fabricated from a second material, wherein said second material differs from said first material.

15. The lens assembly of claim 14, wherein said first material is an acrylic polymer.

16. The lens assembly of claim 15, wherein said second material is a polycarbonate polymer.

17. The lens assembly of claim 13, wherein said first lens portion further includes a translucent first side surface, wherein light entering said first lens portion at said first base is optically confined within said first lens portion by said translucent first side surface.

18. The lens assembly of claim 17, wherein said second lens portion further includes a translucent second side surface, wherein light entering said second lens portion at said second base is optically confined within said second lens portion by said translucent second side surface.

19. The lens assembly of claim 18, wherein each of said first and second lens portions are adapted to optically confine light into an optimized beam.
